(19) United States
(12) Patent Application Publication
(10) Pub. No.: US 2010/0268600 A1
(43) Pub. Date: Oct. 21, 2010

(54) ENHANCED ADVERTISEMENT TARGETING

(75) Inventors: Michele L. Banko, Seattle, WA (US); Krzysztof Koperski, Seattle, WA (US); Jisheng Liang, Bellevue, WA (US); Aniruddha Gadre, Clyde Hill, WA (US); Christopher J. Barrows, Seattle, WA (US)

Correspondence Address: BLACK LOWE & GRAHAM, PLLC, 701 FIFTH AVENUE, SUITE 4800, SEATTLE, WA, 98104, US

(73) Assignee: EVRI INC., Seattle, WA (US)

(21) Appl. No.: 12/758,690

(22) Filed: Apr. 12, 2010

Related U.S. Application Data
(60) Provisional application No. 61/169,988, filed on Apr. 16, 2009.

(51) Int. Cl. G06Q 30/00

(52) U.S. Cl. 705/14.52

(57) ABSTRACT

Methods, techniques, and systems for advertisement targeting are provided. Example embodiments provide an enhanced ad targeting system (“EATS”), which given one or more products, determines keywords to associate with those products and which, given one or more entities, determines related products for which ads can be targeted. In some embodiments, the EATS uses semantic analysis and relationship searching to aid in the selection of ads more relevant to a context or search query.

### TECHNICAL FIELD

The present disclosure relates to methods, techniques, and systems for targeting advertisements and, in particular, to methods and systems for targeting advertisements using semantic techniques or by recognizing popular entities or products.

### BACKGROUND

A multitude of online content exists, including news stories, personal web pages, social content, product information, etc., which can be potentially viewed by multiple millions of individuals. The Internet, and more specifically, the Worldwide Web (the “Web”), has become a medium of choice for disseminating news stories and other content to millions of individuals. News content providers, like many others delivering online services, are providing such content based upon an advertising revenue model, but typically use online, often dynamic, advertisements presented on web pages along with the primary content or linked in some manner to the primary content. In some online advertising models, the content is associated with potentially embedded keywords that are in turn associated with advertisements. This is known as “contextual advertising.” For example, keywords in an article may be linked to different advertisements, or the advertisements may be displayed concurrently based upon the set of keywords associated with or found within the article.

In some such instances, at least a portion of such advertising revenue is distributed to the content providers based upon the frequency an advertisement results in a visit to an underlying website page that provides the advertised product/service/feature. Such a model is sometimes referred to as a pay-per-click (or cost-per-click) payment model. Other models for payment to the content provider exist, such as cost-per-impression, cost-per-view, cost-per-engagement, etc., some of which require a specific interaction with the advertisement to generate advertising revenue. Accordingly, the better the advertisements are linked to the content, the more potentially relevant and alluring the advertisements.

In other scenarios, search engines, such as Google or Yahoo! provide information and other content in response to a user initiating some kind of, typically word-based, search. Similar to news and other service providers, many such search engines sell space and display advertisements as a way to earn revenue for delivering content for free or at a reduced cost to the viewer. Often, the advertisers bid for and pay for “advertising space” based upon certain keywords or combinations of keywords. Some such search engines present advertisements along with the links (e.g., uniform resource identifiers or uniform resource locators) that contain the web page content resulting from executing the search. These advertisements may be presented, for example, in a special advertising area, such as a sponsored links area, to indicate to the viewer that the links listed in the area are advertisements. The advertisements are typically linked to one or more of the search terms specified by the viewer in the search query. Again, payment model options may be similar to those for news providers.

FIG. 1 is an example of sponsored advertisements presented concurrent with search results displayed by a search engine. In this example, the user has entered the search terms “Patagonia down sweater” in search input area 100. The search engine displays search results in search result area 120, which typically includes links to web pages containing matching content, such as link 110. The search engine also displays links to related advertisements (in this case to at least one of the search terms) in sponsored links areas 101 and 102. For example, in FIG. 1, the advertisements displayed in sponsored link areas 101 and 102 relate at least to the primary search term “Patagonia.”

According to at least some advertisement revenue payment models, the more frequently an advertisement results in a viewing of or click-through to the underlying advertised item, the more the content provider earns. Accordingly, the more apropos the advertisement is to the viewed content, typically, the greater chance the advertisement is potentially useful to the viewer, hence visited. Thus, there is a great incentive to those entities participating in earning advertisement revenue to present advertisements that are somehow meaningful to the viewer. There is also a great incentive for the entities selling or otherwise offering the products/services/features to purchase advertisements in the most cost effective manner: that is, to purchase online space where it will create the most impact. In the online world, space is purchased based upon bidding for keywords.

### BRIEF DESCRIPTION OF THE DRAWINGS

FIG. 1 is an example of sponsored advertisements presented concurrent with search results displayed by a search engine.

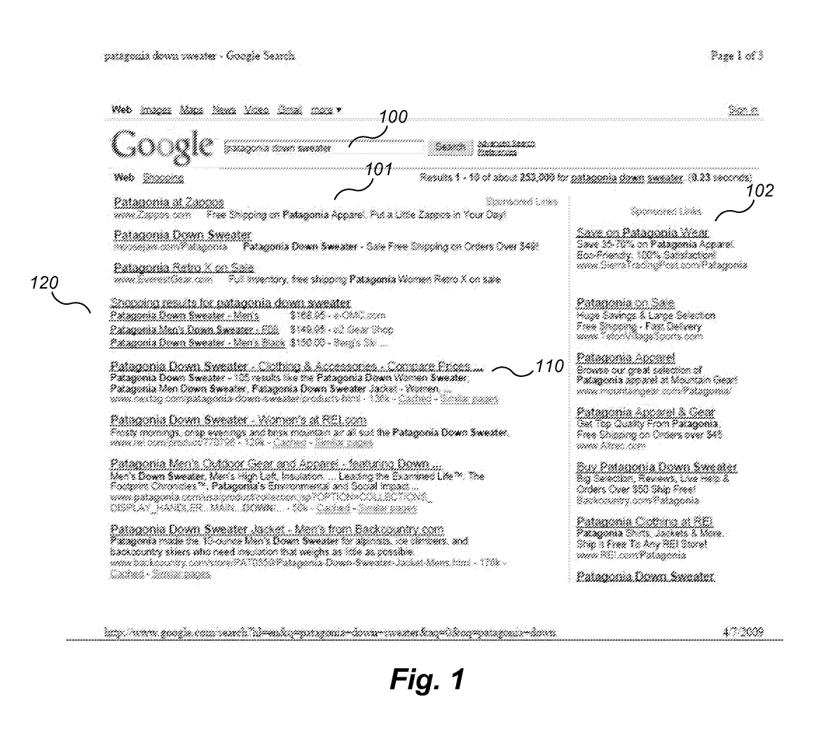

FIG. 2 is an example block diagram of an overview of an example enhanced ad targeting system used to recognize products and related terms from content or from other entity sources to enable serving targeted advertisements.

FIG. 3 is an example block diagram of an example embodiment of an enhanced ad targeting system referred to as a semantic ad targeting system for recognizing products and related terms using semantic analysis of the underlying content.

FIG. 4 is an example block diagram of an overview of an example enhanced ad targeting system used to recommend and identify keywords for associating with targeted advertisements for particular products.

FIG. 5 is an example block diagram of an example embodiment of a semantic ad targeting system used to generate targeted keywords to relate to products and ads.

FIG. 6 is an example block diagram of a computing system for practicing embodiments of an enhanced advertisement targeting system such as a semantic ad targeting system.

FIG. 7 is an example flow diagram of an example routine provided by an enhanced ad targeting system for presenting advertisements based upon entities deemed currently popular.

FIG. 8 is an example flow diagram of an example routine provided by an enhanced ad targeting system for presenting advertisements based upon products deemed currently popular.

### DETAILED DESCRIPTION

Embodiments described herein provide improved computer- and network-based methods, techniques, and systems for online advertising. Example embodiments provide an enhanced advertisement (“ad”) targeting system (“EATS”), which enables advertisers (which in some cases may include content providers) to offer more targeted keywords for creators of advertisements to bid upon and/or for ad selection systems to serve up more relevant advertisements based upon a better understanding of the underlying content. For example, in some embodiments the EATS uses semantic analysis techniques to better understand the underlying content and/or to recognize products related to the content so that advertisements can be better targeted and advertise products more aptly related to what is being displayed. Such an embodiment is referred to herein as a Semantic Ad Targeting system or “SATS.” In other embodiments, products and/or keywords are recognized by means other than using semantic analysis of the content. In addition, some embodiments of an EATS provide mechanisms for auditing and tracking which entities and products are popular at any given time and for enabling advertisers to respond in near-real time with advertisements of products that relate to such popular (e.g., “hot”) entities and products.

Example embodiments of an EATS/SATS illustrated below address at least two main ad targeting problems: 1) given one or more (a set of) products, an advertiser desires to obtain a list of keywords related to those products for the purpose of associating (e.g., tying or linking) ads to content and for controlling financial commitment to various ad opportunities; and 2) for any given content, determine a set of products related to that content so that appropriate ads can be served or presented when such content is viewed by a user.

In the former scenario of obtaining a list of keywords for a set of given products, the determined keywords may be used as indicators of locations where associated ads can be potentially displayed and also may be used as part of revenue models that allow advertisers to “bid” on particular keywords or to pay different costs based upon associations with the keywords. For example, for contextual advertising purposes, when one of the keywords is displayed (and recognized) in the underlying content, one or more of the advertisements associated with those keywords are potentially displayed. Which advertisements are displayed may be controlled by a variety of factors, including for example, who has paid the most for associating ads with those keywords, the amount of room to display some number of ads in conjunction with the underlying content, etc. Contextual advertising refers generally to the ability to display ads that somehow relate to presented online content such as by news reporters, blogs, posts, syndications, etc. For search engine purposes, when one of the keywords is recognized as part of a search query, one or more of the advertisements associated with those keywords are potentially displayed.

In the latter scenario of determining products related to underlying content, the more appropriate the advertisement to the underlying content, the potentially more likely the advertised product will result in a sale or financial distribution of some sort. This assessment may be used for contextual advertising or for search based advertising. Further, the related products may be indirectly associated yet still be related to the underlying content. In addition, in some scenarios, sentiment (negative or positive) may be accounted for, allowing further evaluations of appropriateness of advertisements.

Determining a set of related products to the underlying content may involve more than mere keyword recognition and matching. For example, some SATS embodiments support a determination of related products based upon relationship searching technology as described in detail in U.S. patent application Ser. No. 11/012,089, filed Dec. 13, 2004, and entitled “METHOD AND SYSTEM FOR EXTENDING KEYWORD SEARCHING TO SYNTACTICALLY AND SEMANTICALLY ANNOTATED DATA,” issued as U.S. Pat. No. 7,526,425, and based upon entity recognition and disambiguation technology as described in detail in U.S. patent application Ser. No. 12/288,158, filed Oct. 15, 2008, and entitled “NLP-BASED ENTITY RECOGNITION AND DISAMBIGUATION,” both of which are incorporated herein by reference in their entirety. The use of relationship searching, enables the SATS to establish second order (or greater order) relationships of products to the underlying content (i.e., products related to products which are somehow related to the entities mentioned in the underlying content). Relationship searching can be done relative to the article/content in question, as well as over a large corpus of articles that provide “background knowledge”. This aspect can be very useful when ad inventory may not provide an appropriate advertisement for a recognized entity. For example, if an article about actors Jennifer Aniston and Owen Wilson is being displayed, the SATS might return an indication that “Marley and Me” (the name of a movie in which they both acted) is a related product. However, in some situations, the ad inventory may not include ads for the movie or the movie may not have been directly referred to in the content. In such a case, an advertisement of a book having the same author as the book used as the basis for the movie may result in a relevant advertisement. The use of entity recognition and disambiguation technology enables a SATS to better understand what products may relate to presented content. For example, entities having two different senses can be recognized and result in determinations of related products based upon an “understanding” of the content/search query—not just pattern matching. For example, understanding that displayed content refers to the city “Paris” in the country “France” and not the celebrity “Paris Hilton” can result in the selection and display of very different advertisements, which may increase their overall effectiveness.

In addition, using the capabilities of semantic analysis and relationship searching, it is possible for the SATS to determine whether the sentiment of any content (e.g., a page or group of pages) is positive, negative or neutral toward any entity or product by, for example, determining whether the words associated with the entity/product are positive or negative in tone. In addition, using the auditing and tracking capabilities of some embodiments of an EATS/SATS, the system can determine whether overall sentiment on the web (or subsets of the web, e.g., newspaper sites, political blogs, etc.) about an entity is positive, negative or neutral (and the direction in which it's heading). With this information, the EATS/SATS can perform “dynamic blocking” by blocking ads for a product on a page where it is referenced negatively (or even entirely suspending ads for that product), and also by suggesting “negative keywords” that advertisers should block when placing a keyword bid. So, for example if the EATS/SATS becomes aware that the term “peanut butter” is becoming associated with the negative term “poisoning,” it can automatically block peanut butter ads from showing up on pages where the term “peanut butter” is associated with the term “poisoning.” In addition, the EATS/SATS could raise a flag for an advertiser that it might want to stop advertising that product entirely or not bid on particular keywords.

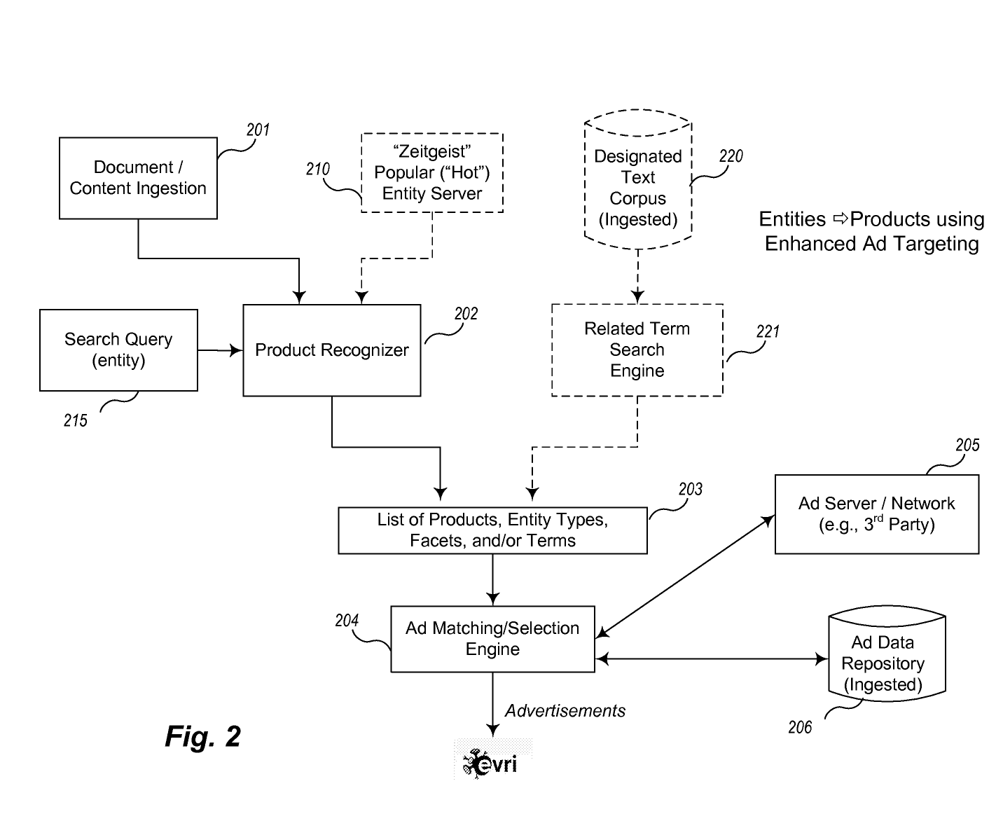

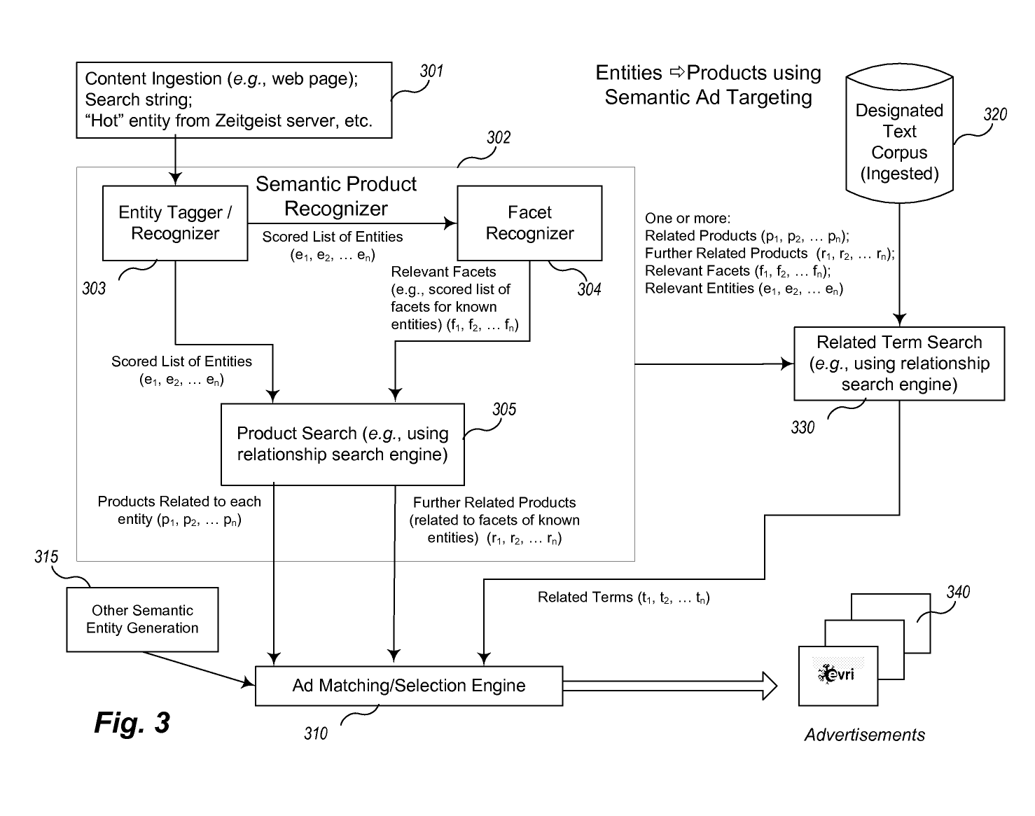

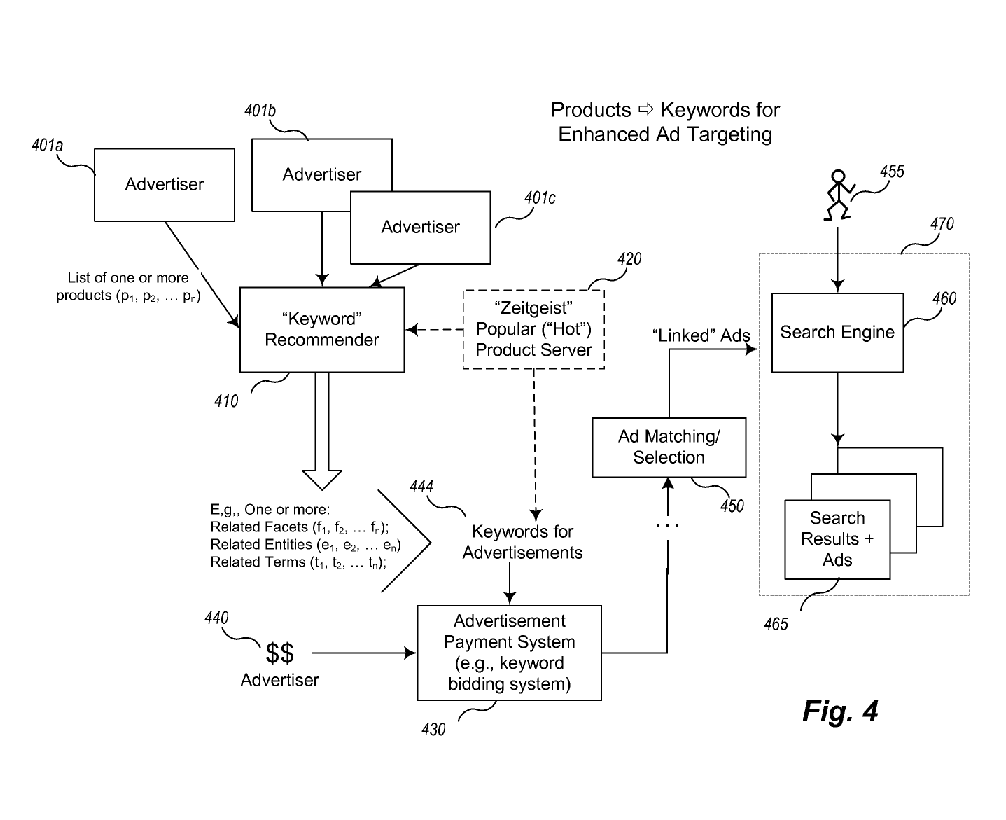

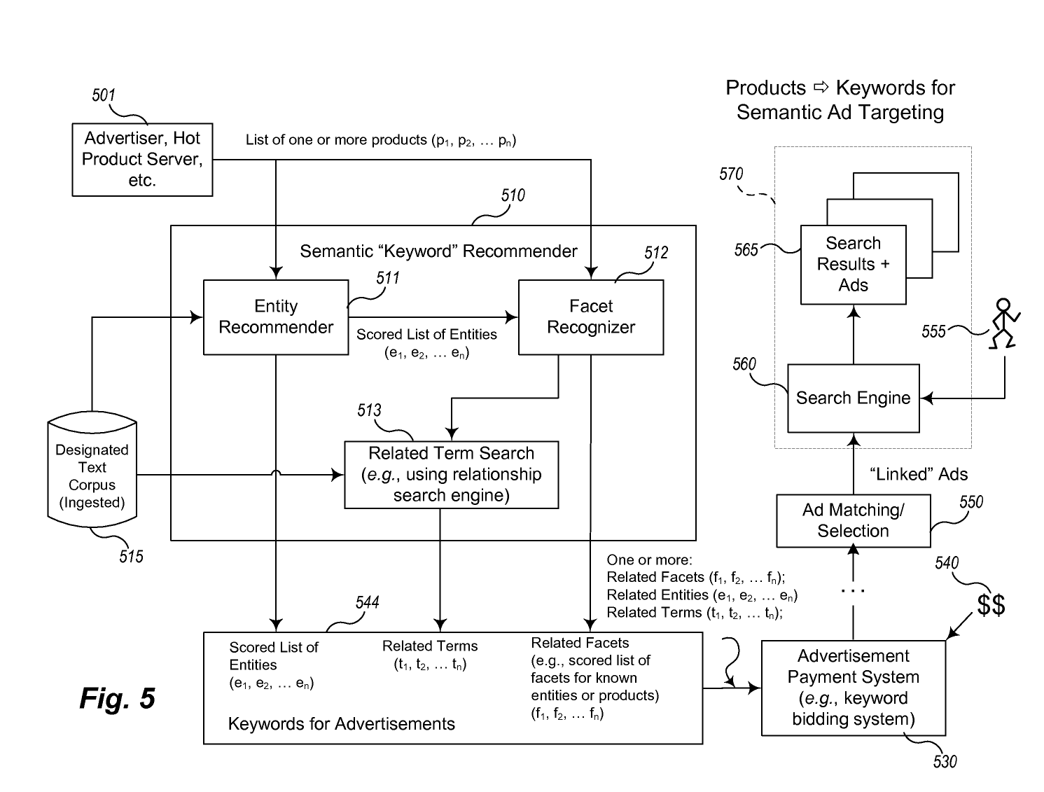

FIGS. 2 and 3 demonstrate the abilities of example embodiments of an EATS/SATS to target ads based upon finding related products to presented content. FIGS. 4 and 5 demonstrate the abilities of example embodiments of an EATS/SATS to generate keywords for products.

FIG. 2 is an example block diagram of an overview of an example enhanced ad targeting system used to recognize products and related terms from content or from other entity sources to enable serving targeted advertisements. In particular, given one or more entities, the example EATS recognizes related products and optionally other related terms, and uses them to match/select advertisements for display with content, for example for use in contextual advertising or with search results. In particular, product recognizer 202 may take input of one or more entities from various sources including from ingesting (into an indexing system typically for further searching) documents or content 201, from a search phrase of one or more terms 215, or optionally from a server of “hot” (popular) entities 210. In at least one embodiment, the popular entity server 210, known as “Zeitgeist,” tracks which entities (including products) are currently popular and reports this data as needed. In some embodiments Zeitgeist tracks the first derivative of mentions of entities, in order to observe “spikes” in activity—not just amount. The product recognizer 202 may use semantic analysis techniques (described in more detail in FIG. 3) to determine related products, or may use other techniques such as straight pattern matching, to determine a list of products, entity types, facets (more finely granular characteristics of entities such as categories like “sports,” “playwright,” “journalist,” etc.), and/or other terms 203 present in the examined content. Appendix C, incorporated herein by reference, includes a list of example entity types. Appendix D, incorporated herein by reference, includes a list of example facets for the various entity types. Fewer or more can be made available. In addition, in some embodiments, additional related terms are added to list 203 by performing relationship searches of designated portions or all of a text corpus 220 ingested for searching by search engine 221. In some embodiments, the search engine 221 is a relationship search engine. Once the list 203 is derived, the list is used, for example, with an ad matching/selection engine 204 to determine what advertisements to display, for example, alongside other displayed content such as a news report or search result. The ad matching/selection engine 204 may present the list of related products, etc. 203 (e.g., as a scored list) to an ad server/network 205 such as a 3^{rd} party ad server and allow the ad server/network 205 to select appropriate ads from its inventory and target them to the content, or may use the list 203 with an Application Programming Interface (“API”) supported by the ad server to more finely control the returned ads, or may search previously ingested ad inventory from an ad data repository 206. For example, the ad server 205 (or the matching engine 204 using the API) could map the product keywords returned in list 203 to words included in ads in its inventory and serve those ads, or it could map the facets returned in list 203 to the categories of ads it sells to advertisers. For example, if an advertiser wants an ad placement in the “sports” category and a facet of “football team” is returned for an article, then the ad network could map “football team” to its “sports” category and serve an ad from that category. Other arrangements and components for serving ads are possible, and the ad server 205 and ad data repository 206 may be separate from or incorporated into the ad matching/selection system 204.

Of note, FIGS. 2 and 3 assumes that ads appropriate to various products have been create/generated, appropriately paid for and made available. Thus, the mechanism described in FIGS. 2 and 3 can be independent from how the ads are generated or made available.

FIG. 3 is an example block diagram of an example embodiment of an enhanced ad targeting system referred to as a semantic ad targeting system for recognizing products and related terms using semantic analysis of the underlying content. FIG. 3 presents a more detailed view of some of the components of FIG. 2, for example the product recognizer 202, to illustrate some of the semantic capabilities of the SATS. Thus, similar to FIG. 2, one or more entities are passed in component 301 via content ingestion, a search query, a previously discovered entity, or an indicated “hot” entity to semantic product recognizer 302. The input is analyzed and disambiguated using entity tagger/recognizer 303 and a scored list of entities (e₁, e₂, . . . eₙ) results. This entity list may be scored according to any appropriate algorithm, for example, by the most frequently mentioned entities in the content. The list of entities is then passed to a facet recognizer 304, which analyzes the entity list to generate a scored list of facets (f₁, f₂, . . . fₙ) that are, for example, the most commonly shared facets (characteristics) of a subset of the entity list that are “known” to the system. (There may be some entities returned in the entity list that are unknown to the system, and no relevant facets are likely generated.) The scored list of entities and the scored list of facets are then fed into a product search tool 305 to determine the products related to each entity (p₁, p₂, . . . pₙ) and the further related products to each facet (r₁, r₂, . . . r₃). In some embodiments, these are also ordered so that only the top ‘n’ related products are returned for each of the entities and each of the facets. In some embodiments, one or more of the related products, further related products, relevant facets, and/or relevant entities are fed into a search engine 330 to be compared with a portion or all of an ingested text corpus 320 to determine further related terms (t₁, t₂, . . . t₃) that may be associated with the recognized entities and facets. These terms may be used to generate even more related products, to help order the related products, or to refine the advertisement matching that is performed by ad matching/selection engine 310. The list of related products, further related products, optionally related terms, and other sources of generating entities 315 are then fed into the ad matching/selection engine 310, which interfaces as described with reference to FIG. 2, to generate relevant advertisements 340.

In some embodiments, the product recognizer 302 determines the entities using entity tagger/recognizer 303, queries a database (not shown) of known entities and/or other ingested text (e.g., corpus 320) to generate the list of products, and then scores the products. The products can be scored in terms of relevance to the page, for example: (i) related products actually mentioned in the article may be scored higher than products not mentioned in the article; (ii) products related to more than one entity on a page might score higher than products related to only one entity (so, on a page about Jennifer Aniston and Owen Wilson, the “Marley & Me” DVD would rank higher than the “Friends” DVD set; but on a page about Jennifer Aniston and Courtney Cox, the results would be the opposite); (iii) products relating to the entity that is most prominent on the page may be ranked higher than products relating to less prominent entities on the page, etc.; and (iv) products can also be scored based on date relevance (e.g., recent articles about Jennifer Aniston mention her relationship to Marley & Me compared to 10 years ago when content discussed the actress relative to Friends).

Also, the facet recognizer 304 may recognize facets in different ways. For example, first, if all or some of the entities on the page share facets (like “politician” or “author”), the semantic product recognizer 302 would know that that the facet is relevant to the page. Second, if the products related to those entities have substantial overlap in terms of facets, the recognizer 302 would know those overlapping facets are relevant to the page (e.g., if many of the products related to entities on the page have the facet “magazine”), then “magazines” are a relevant facet for the page. The facets can then be scored in terms of relevance for the page (possibly weighting primary facet more heavily than secondary facets, e.g., for a page about Barack Obama and Al Gore, “politicians” would presumably score higher than “authors”).

As mentioned above, the SATS in conjunction with the ad selection technology can support second-order (or n-order) relationships. For example, the ad matching/selection engine 310 could parse an ad network's ad inventory to enable display of relevant ads even where there is no obvious keyword or category match. For example, if a page relates to Jennifer Aniston and Owen Wilson, the SATS might return “Marley & Me” as a related product, and “actors” as a related facet. If the ad network has no ads that contain “Marley & Me” or ad categories that map to “actors”, without more information, it may run a generic ad or at best one relating to “entertainment” generally. However, the SATS is able to search the ad corpus for second-order related products (i.e., products related to products related to the entities in the article). So, for example, if there was no match for the related product “Marley & Me” in the ad inventory, the engine 310 might search their inventory for an ad with keywords matching a product related to “Marley & Me” (e.g., another book by the same author) and thereby turn up a more relevant ad.

Appendices A and B, incorporated herein by reference in their entirety, illustrate an example of using a SATS such as that described with reference to FIG. 3 above to recognize related products in underlying content. Appendix A shows an article in an online newspaper about presenting Queen Elizabeth II with an iPod. Appendix B illustrates a set of entities and facets (herein listed as categories) discovered by the semantic product recognizer 302 in the underlying article. Under each entity and facet, a list of the top “n” related products are shown. The “misc” entry refers to “unknown” entities that appear in the article. These are entities for which no information is known by the SATS and are repeated here for completeness. The numbers by each related product (under an entity or a facet) refers to a score of the probability that product is likely to be associated with that entity or facet relative to a text corpus known to the SATS. Other scoring and ordering mechanisms can be similarly incorporated.

FIG. 4 is an example block diagram of an overview of an example enhanced ad targeting system used to recommend and identify keywords for associating with targeted advertisements for particular products. In particular, given one or more products, the example EATS determines an appropriate set of keywords (e.g., entity names or facets) for associating ads with these products. The keywords may be used as part of a payment or bidding system to determine when certain ads are potentially available for display and may be used to indicate when to display them in contextual advertising or in a search result (and even potentially where to display an associated ad). In particular, keyword recommender 410 may take input of one or more products from various sources including from different advertisers 401a-401c, or optionally from a server of “hot” (popular) products 420. In at least one embodiment, the popular product server 420, known as “Zeitgeist,” tracks which products are currently the most popular and reports this data as needed. In some embodiments Zeitgeist tracks the first derivatives of mentions of products, in order to observe “spikes” in activity—not just amount. The keyword recommender 410 may use semantic analysis techniques (described in more detail in Fig. E) to determine related keywords, or may use other techniques such as straight pattern matching, to determine a list of entities, facets (categories), and/or other terms from which the keywords 444 may be selected. Once the keywords 444 (which may be entity names, facets or terms) are selected for use, the various advertisers may commit finances 440 through some sort of payment system (e.g., a bidding system) to associate their ads with the particular keywords. At this point the ads for the various products are then made available to EATS for selection through ad matching/selection engine 450 and display. These ads may be selected and displayed on a page 470 as with contextual advertising (not shown), or in conjunction with a search result, as shown through the use of search engine 460 to generate search results and ads 465 in response to a user query 455.

FIG. 5 is an example block diagram of an example embodiment of a semantic ad targeting system used to generate targeted keywords to relate to products and ads. Given one or more products, for example passed in by an advertiser, “hot” product server, etc. 501, the semantic keyword recommender 510 determines various entities, facets, and terms that may be used as keywords to associated with ads. More specifically, the recommender 510 includes an entity recommender 511, which generates a scored list of entities (e₁, e₂, . . . eₙ)); a facet recognizer 512, which generates a scored list of facets (f₁, f₂, . . . fₙ); and a related term search engine 513, which, in one embodiment performs relationship (semantic) searches against a designated text corpus 515 to generate a set of related terms (t₁, t₂, . . . tₙ). Although shown as using semantic processing, one or more of these components could generate their respective lists by other means.

In one embodiment, the entity recommender 511 determines which entities the product is related to and returns a scored list of entities for use as keywords, with scoring possibly based on frequency of co-occurrence+recency. So, for example, if a vendor is interested in selling Vogue magazine, the entity recommender 511 can determine (using relationship searching, e.g., using the IQL/RQL search string “Vogue< >*< >”) that Vogue is related to Anna Wintour, Michelle Obama, Melinda Gates and Annie Leibowitz. The recommender 511 could then recommend that rather than bidding on just “Vogue”, the advertiser bid on “Annie Leibowitz”, or “Vogue+Melinda Gates” or “Vogue+Michelle Obama+Annie Leibowitz”.

In addition, in some embodiments if the recommender 511 cannot find related entities using the RQL search string, it can extend its search to include other highly related entities. For example, should an entity such as Greg Nickels, the mayor of Seattle not be directly related to any products, recommender 511 can recommend products related to his most strongest association—products related to Seattle.

Similarly, in one embodiment the facet recognizer 512 can determine what facets relate to the product (e.g., “magazine”) and suggest those as keywords or in combination with other keywords. For example, the advertiser above could bid on “Vogue+magazine” or “Michelle Obama+magazine”, etc.

In addition to entities and facets as keywords, the semantic keyword recommender 510 can suggest terms that are related to the products, which can also be used as keywords, by finding terms (in a text corpus) that a type of product is frequently associated with. More specifically, the related term search engine 513 can: (i) determine what facets relate to set of products (e.g., “magazine” in the case of Vogue, New Yorker, Time); (ii) query a database of articles (or a subset, like only Wikipedia articles), for example text corpus 515, to see what terms are frequently used in conjunction with entities that share those facets but not other facets (e.g., the term “subscription” is highly associated with “magazines, including other magazines like Vanity Fair, the Economist, Scientific American, Sports Illustrated, etc. but less so than with computers); (iii) then determine which of those terms are frequently used in conjunction with references to Vogue specifically in the database of articles (or subset thereof, like Wikipedia articles); and (iv) return those terms to the advertiser as keywords. So, for example, if “fashion” and “designer” are frequently associated with a number of magazines and particularly with the product “Vogue”, the keyword recommender 510 could recommend that advertisers bid on the keywords “Vogue fashion” or “Vogue designer”, or, in combination with then entities and facet examples above, “Melinda Gates+fashion” or “designer magazine” or “Vogue+Annie Leibowitz+fashion+magazine”. Also, although “finance,” “short fiction” and “pc reviews” may also be terms highly associated with magazines, the keyword recommender 510 could determine not to recommend the terms for magazines such as Vogue.

In addition, in some embodiments, sentiment is taken into account. The recommender 510 can suggest “negative keywords” that advertisers should block when placing a keyword bid. So, for example if the SATS knows that the term “peanut butter” is becoming associated with the negative term “poisoning” (for example, as determined by the Zeitgeist server), the recommender 510 could raise a flag for an advertiser/content provider that it might want to stop advertising that product entirely, and could specifically instruct a search engine not to bid on keywords like “peanut butter poisoning,” “peanut butter recall,” etc., even if in general advertisers were bidding on the keyword “peanut butter.”

Once these potential keywords 544 are generated, then one or more of them may be used as input to an advertisement payment system such as bidding system 530. Advertisers would then pay money 540 to associate their ads with various keywords. At this point the ads for the various products are then made available to SATS for selection through ad matching/selection engine 550 and display. These ads may be selected and displayed on a page 570 as with contextual advertising (not shown), or in conjunction with a search result, as shown through the use of search engine 560 to generate search results and ads 565 in response to a user query 555.

The techniques of SATS are generally applicable to any type of ad targeting. Also, although the examples described herein often refer to a relationship search engine, the techniques described herein can also be used by other types of search engines to determine related products and keywords. Also, the techniques do not have to be constrained to products—they are applicable to any kind of related entities. In addition, the concepts and techniques described are applicable to serving other related content other than advertisements. Essentially, the concepts and techniques described are applicable to any kind of related content targeting. Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement an Enhanced Ad Targeting System to be used for associating ads with content. Other embodiments of the described techniques may be used for other purposes, including for rating advertisements. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the scope of the techniques and/or functions described are not limited by the particular order, selection, or decomposition of steps described with reference to any particular routine.

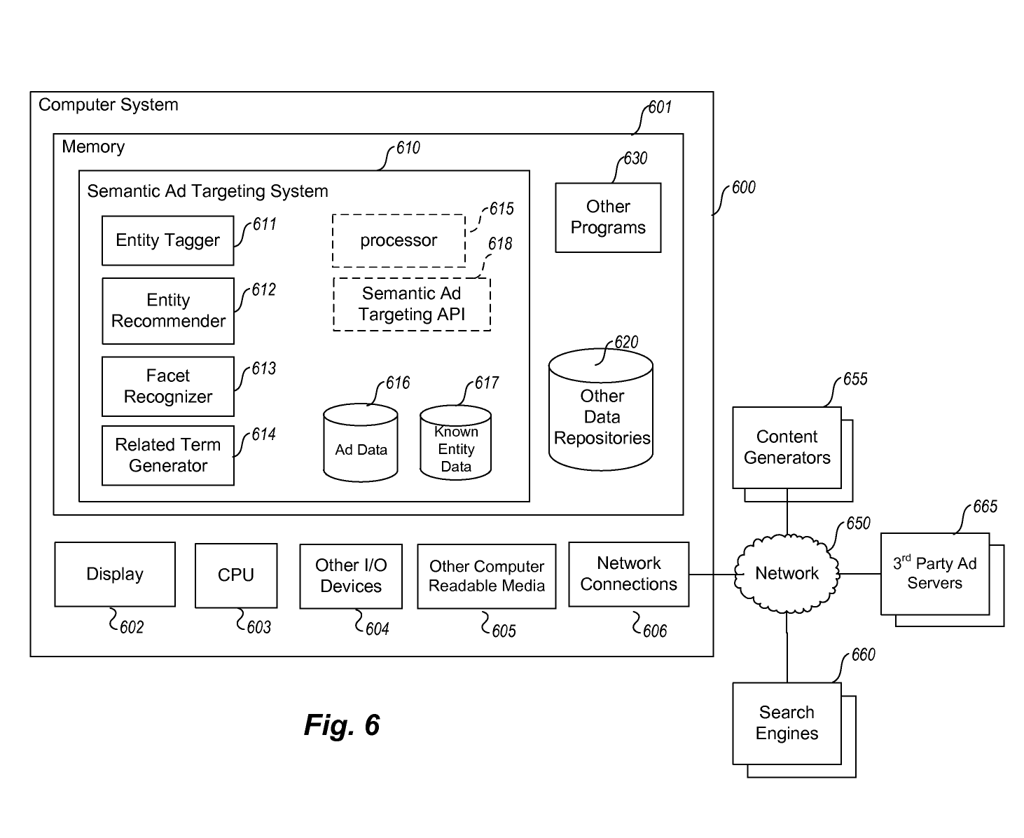

FIG. 6 is an example block diagram of an example computing system that may be used to practice embodiments of an enhanced advertisement targeting system such as a semantic ad targeting system. Note that a general purpose or a special purpose computing system suitably instructed may be used to implement an EATS or a SATS. Further, the EATS/SATS may be implemented in software, hardware, firmware, or in some combination to achieve the capabilities described herein.

The computing system 600 may comprise one or more server and/or client computing systems and may span distributed locations. In addition, each block shown may represent one or more such blocks as appropriate to a specific embodiment or may be combined with other blocks. Moreover, the various blocks of the EATS/SATS 610 may physically reside on one or more machines, which use standard (e.g., TCP/IP) or proprietary interprocess communication mechanisms to communicate with each other.

In the embodiment shown, computer system 600 comprises a computer memory (“memory”) 601, a display 602, one or more Central Processing Units (“CPU”) 603, Input/Output devices 604 (e.g., keyboard, mouse, CRT or LCD display, etc.), other computer-readable media 605, and one or more network connections 606. The EATS/SATS 610 is shown residing in memory 601. In other embodiments, some portion of the contents, some of, or all of the components of the EATS/SATS 610 may be stored on and/or transmitted over the other computer-readable media 605. The components of the EATS/SATS 610 preferably execute on one or more CPUs 603 and manage the serving and targeting of advertisements, as described herein. Other code or programs 630 and potentially other data repositories, such as data repository 620, also reside in the memory 601, and preferably execute on one or more CPUs 603. Of note, one or more of the components in FIG. 6 may not be present in any specific implementation. For example, some embodiments embedded in other software may not provide means for user input or display.

In a typical embodiment, the EATS/SATS 610 includes one or more Entity Taggers 611, one or more Entity Recommenders 612, one or more Facet Recognizers 613, and one or more Related Term Generators 614. In at least some embodiments, the Related Term Generators are provided external to the EATS/SATS and are available, potentially, over one or more networks 650. Other and/or different modules may be implemented. In addition, the EATS/SATS may interact via a network 650 with content generator code 655 that provides underlying content upon which the targeted advertisements may be placed, one or more search engines 660, and/or one or more third-party ad servers 665, such as purveyors of information used in ad data repository 616. Also, of note, the ad data repository 616 may be provided external to the EATS/SATS as well, for example in a knowledge base accessible over one or more networks 650.

In an example embodiment, components/modules of the EATS/SATS 610 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an EATS/SATS implementation.

In addition, programming interfaces to the data stored as part of the EATS/SATS 610 (e.g., in the data repositories 616 and 617) can be available by standard means such as through C, C++, C#, and Java APIs; libraries for accessing files, databases, or other data repositories; through scripting languages such as XML; or through Web servers, FTP servers, or other types of servers providing access to stored data. The data repositories 616 and 617 may be implemented as one or more database systems, file systems, or any other method known in the art for storing such information, or any combination of the above, including implementation using distributed computing techniques.

Also the example EATS/SATS 610 may be implemented in a distributed environment comprising multiple, even heterogeneous, computer systems and networks. For example, in one embodiment, the Entity Tagger 611, the Entity Recommender 612, and the Ad data repository 616 are all located in physically different computer systems. In another embodiment, various modules of the EATS/SATS 610 are hosted each on a separate server machine and may be remotely located from the tables which are stored in the data repositories 616 and 617. Also, one or more of the modules may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an EATS/SATS.

Furthermore, in some embodiments, some or all of the components of the EATS or SATS may be implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

As described in FIGS. 2-5, one of the functions of an enhanced ad targeting system is to identify appropriate products related to the most currently popular entities so that advertisers of products that relate to the most currently popular entities can cause in near real time their ads to be displayed when references to such entities are presented. For example, if an entity, such as an obscure baseball player, suddenly makes the news or is the target of a great number of search requests, then the EATS can identify this phenomena and recognize which products may be in turn related to this “hot” entity and potentially lead to a greater number of product sales by piggybacking upon the popularity of the hot entity. These recognized products can then be used to select targeted advertisements that are associated with such hot entities in near real time (e.g., by having advertisers bid on these hot entities as keywords) or otherwise available as part of an ad inventory.

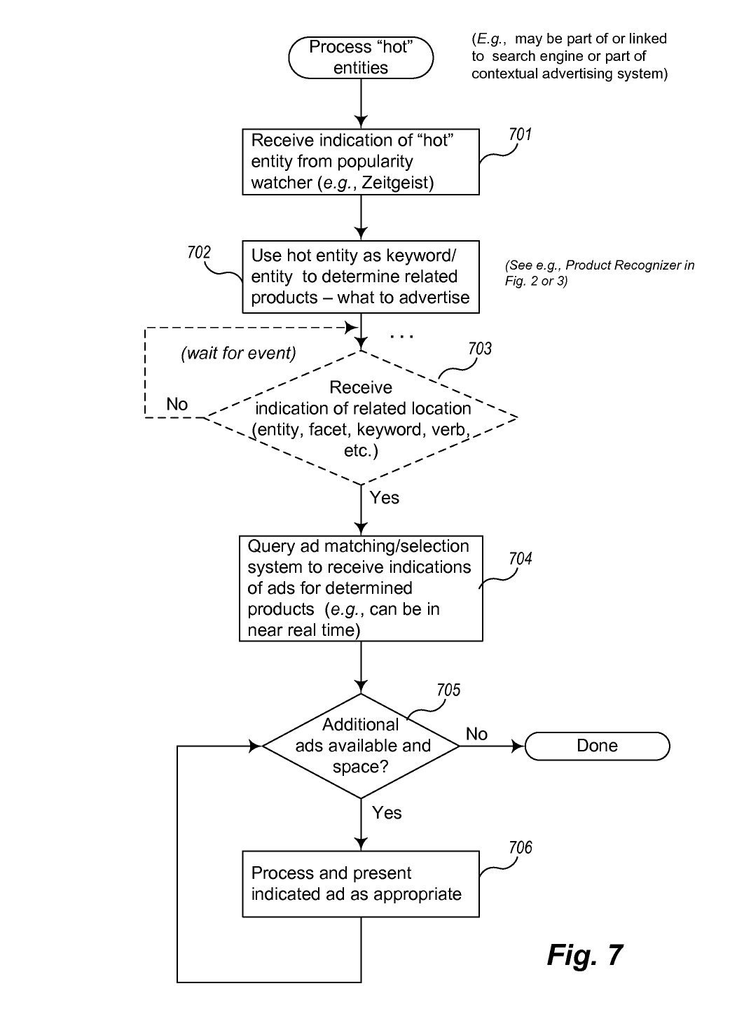

FIG. 7 is an example flow diagram of an example routine provided by an enhanced ad targeting system for presenting advertisements based upon entities deemed currently popular. The routine for processing “hot” entities may be a module or system separate from the system that recognizes the popular entities and may be part of a search engine or a contextual advertising system. For example, in one embodiment, a “Zeitgeist” server monitors and ranks which entities are a subject in most searches and/or other content (e.g., such as news stories) and reports the same to the process of FIG. 7 executing in block 701. In block 702, the popular (“hot”) entity is used to determine related products—in other words, what products to advertise when the hot entity is mentioned in underlying content, searches, etc. The product recognizer 202 or 302 of FIGS. 2 and 3, respectively, may be used to determine a list of such products. Then, in block 703 (potentially at some future time), when the hot entity is mentioned, for example as part of a search query or a report or as part of other web page content, the routine queries in block 704 an ad matching/selection system to retrieve one or more indications of advertisements of products that are hopefully very relevant to the popular entity. For example, if the popular entity is “Michael Phelps” (the Olympian swimmer), then the routine may determine that swimsuits, swim caps, vitamins, etc. are all related products. In block 704, indications of ads relating to these products may be received for processing. In blocks 705-706, advertisements are presented in accordance with the underlying content, for example, if space permits.

Another one of the functions of an enhanced ad targeting system described in FIGS. 2-5 is to identify appropriate keywords for the most currently popular products so that advertisers of such products can associate their advertisements with these products at a time when public interest in the products is high. The advertisers may bid for such identified keywords in near real time (or otherwise associate themselves as part of an ad inventory), so that their ads for these popular products are the ones selected for display when these keywords are encountered, for example, as a result of a search query or as designated in other content. In this manner advertisements can be presented that are targeted to the most currently popular products. For example, if a J.S. Golfer's newest golf club (e.g., a TTEdge putter) is deemed a “hot” product, then keywords such as “golf club,” “putter,” “TTEdge,” “golf” etc. might be identified so that advertisers of related products (e.g., golf ball vendors) may advertise their wares whenever the TTEdge putter or related products are presented (during the time the TTEdge putter is deemed “hot”).

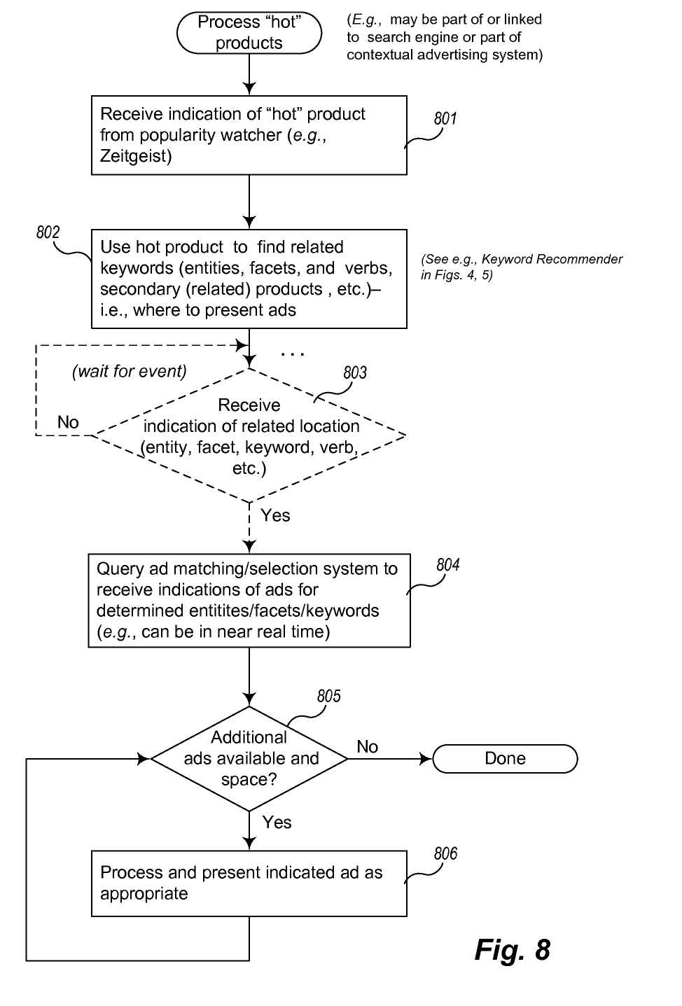

FIG. 8 is an example flow diagram of an example routine provided by an enhanced ad targeting system for presenting advertisements based upon products deemed popular. This routine is somewhat similar to the routine of FIG. 7 in that it may be executed as part of a module or system separate from the system that recognizes the popular products or may be part of a search engine or a contextual advertising system. For example, in one embodiment, a “Zeitgeist” server monitors which products are the subject of the most searches and/or other content (e.g., such as news stories) and reports the same to the process of FIG. 8 executing in block 801. In block 802, the popular (“hot”) product is used to determine related keywords—in other words, where such products should be advertised. Further, these keywords may be used to bid for ad “position” in near real time. The keyword recommender 410 or 511 of FIGS. 4 and 5, respectively, may be used to determine a list of such keywords. Then, in block 803 (potentially at some future time), when the keyword (entity name, product facet, etc.) is mentioned, for example as part of a search query or a report or as part of other web page content, the routine queries in block 804 an ad matching/selection system to retrieve one or more indications of advertisements for the popular product or for products that are hopefully very relevant to the popular product. For example, if the popular product is “tennis racquets”, then the routine may determine that tennis, tennis balls, tennis attire, vitamins, etc. are all related keywords. In block 804, indications of ads relating to these products associated with these keywords may be received for processing. In blocks 805-806, advertisements are presented in accordance with the underlying content, for example, if space permits.

From the foregoing it will be appreciated that, although specific embodiments have been described herein for purposes of illustration, various modifications may be made without deviating from the spirit and scope of the invention. For example, the methods and systems for performing ad targeting discussed herein are applicable to other architectures. Also, the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A computer-implemented method for targeting advertisements to online content, comprising:
determining a particular entity whose popularity has changed in a designated amount of time;
when the particular entity is not a product, determining one or more products that relate to the particular entity and causing advertisements relating to the one or more of the determined one or more products that relate to the particular entity to be presented on a display screen in conjunction with online content that relates to the particular entity; and
when the particular entity is a product, determining one or more keywords that relate to the particular entity and causing advertisements to be associated with the one or more keywords such that one or more of the advertisements are presented on the display screen in conjunction with online content that relates to the determined one or more keywords.

2. The method of claim 1 wherein the keywords are used to implement an advertising bidding system for generating online ad revenue.

3. The method of claim 1 wherein the determining the particular entity whose popularity has changed in a designated amount of time is determined by tracking a first derivative of frequency of online mentions of the particular entity.

4. The method of claim 1 wherein the determining the one or more products that relate to the particular entity is performed by semantically analyzing content where the particular entity is mentioned.

5. The method of claim 1 wherein the determining the one of more keywords that relate to the particular entity is performed by semantically analyzing content where the particular entity is mentioned.

6. The method of claim 5 wherein the content is online content from an article or a document.

7. The method of claim 5 wherein the content is a search engine query.

8. The method of claim 4 wherein the content is on line content from an article or a document.

9. The method of claim 4 wherein the content is a search engine query.

10. A computer-readable medium containing content for controlling a computer processor to perform a method comprising:
determining a particular entity whose popularity has changed in a designated amount of time;
when the particular entity is not a product, automatically determining one or more products that relate to the particular entity and causing advertisements relating to the one or more of the determined one or more products that relate to the particular entity to be presented in conjunction with online content that relates to the particular entity; and
when the particular entity is a product, automatically determining one or more keywords that relate to the particular entity using related entities, related facets, and/or related terms, and causing advertisements to be associated with the one or more keywords such that one or more of the advertisements are presented in conjunction with online content that relates to the determined one or more keywords.

11. The computer-readable medium of claim 10, wherein the medium is a computer memory and the content are computer instructions.

12. An online computing environment, comprising:
a semantic keyword recommender, stored in one or more computer memories, and configured when executed to:
receive one or more indications of products;
determine one or more entities related to the received product indications and one or more categories related to the received product indications;
determine zero or more related terms related to the received product indications; and
generate one or more keywords for associating with online advertisements and return indications of the generated keywords; and
an electronic advertisement payment system that utilizes the generated keywords to make available one or more online advertisements.

13. The computing environment of claim 12, further comprising an advertisement matching selection system that determines an advertisement to present online based upon available advertisements that are associated with one of the one or more determined keywords.

14. The computing environment of claim 12 wherein the determined categories related to the received product indications are facets related to two or more of the determined entities.

15. The computing environment of claim 12 wherein the determined one or more entities related to the received product are determined based upon semantically analyzing content.

16. The computing environment of claim 12 wherein the generate one or more keywords for associating with online advertisements are generated by scoring a list of entities and/or related terms and/or related categories.

17. The computing environment of claim 12 wherein the electronic advertisement payment system is an online keyword bidding system.

18. A computer-readable medium containing content that controls a computer processor to perform a method comprising:
receiving one or more indications of products;
determining one or more entities related to the received product indications and one or more facets related to the received product indications by semantic analysis of online content;
determining zero or more related terms related to the received product indications;
automatically generating one or more keywords for associating with online advertisements and return indications of the generated keywords; and
providing the generated keywords to an electronic advertisement payment system that utilizes the generated keywords to make available one or more online advertisements.

19. The computer-readable medium of claim 12, wherein the medium is a computer memory and the content are computer instructions.

20. An online computing environment, comprising:
a semantic product recognizer, stored in a computer memory and configured, when executed to:
receive one or more indications of entities; and
determine one or more corresponding related products; and
an advertisement matching selection engine, stored in a computer memory and configured, when executed to:
determine one or more advertisements that correspond to the determined one or more related products; and
present the determined one or more advertisements in conjunction with content regarding the received one or more indications of entities.

21. The online computing environment of claim 20 wherein the advertisement matching selection engine is further configured to communicate with an ad server to determine the one or more advertisements that correspond to the determined one or more related products.

22. The online computing environment of claim 20 wherein the advertisement matching selection engine is further configured to access an advertisement data repository to determine the one or more advertisements that correspond to the determined one or more related products.

23. The online computing environment of claim 20 wherein the semantic product recognizer is further configured, when executed to:
determine the one or more corresponding related products by tagging and/or recognizing entities in underlying content and determine categories related to the tagged and/or recognized entities.

24. The online computing environment of claim 23 wherein the categories are facets related to two or more of the tagged and/or recognized entities.

25. The online computing environment of claim 23 wherein the semantic product recognizer is further configured, when executed to:
determine the one or more corresponding related products by determining products related to the determined categories.

26. The online computing environment of claim 20 wherein the one or more indications of entities are received from semantically analyzing content.

27. The online computing environment of claim 26 wherein the content is a search engine query.

28. A computer-readable medium containing content that controls a computer processor to perform a method comprising:
receiving one or more indications of entities;
determining one or more corresponding related products; and
providing the determined related products to an advertisement matching selection engine that is configured to determine one or more advertisements that correspond to the determined one or more related products, such that the advertisements can be presented in conjunction with content regarding the received one or more indications of entities.

29. The computer-readable medium of claim 20, wherein the medium is a computer memory and the content are computer instructions.
